(19) United States
(12) Patent Application Publication
(10) Pub. No.: US 2009/0235581 A1
(43) Pub. Date: Sep. 24, 2009

(54) Apparatus to prevent climbing a vertically disposed member

(76) Inventors: Charles W. Bevins, Vero Beach, FL (US); Sean Smith, Vero Beach, FL (US)

Correspondence Address: James Ray & Associates, 2640 Pitcairn, Road, Monroeville, PA, 15146, US

(21) Appl. No.: 12/077,977

(22) Filed: Mar. 24, 2008

(51) Int. Cl. A01G 13/02

(52) U.S. Cl. 47/32.5

(57) ABSTRACT

An apparatus to prevent climbing a vertically disposed member is provided. The apparatus includes a covering member manufactured from a predetermined material and having a predetermined shape, a predetermined thickness, and a predetermined size. A securing mechanism is operably connected to such covering member at a predetermined location thereon for securing such covering member at least one of to and around a predetermined object such that such object is rendered substantially incapable of being climbed upon at the location covered by the covering member.

### FIELD OF THE INVENTION

The present invention relates, in general, to protective devices and, more particularly, this invention relates to devices which deter animals from climbing and destroying property housed, stored, and disposed on or extending from tree branches, posts, poles and the like.

### BACKGROUND OF THE INVENTION

Prior to the conception and development of the present invention, tree guards, as are generally well known in the prior art, have been used to protect trees and plants from animals. Specifically of interest to the present invention are the following: Staggs, U.S. Pat. No. 6,588,144, provides a tree guard for young trees, seedlings, saplings and other plants which is a flat sheet having locking wing shaped tabs and receiving cut outs in the sheet positioned so as to securely receive and hold the wing shaped locking tabs such that when the sheet is rolled into a cylindrical shape the side ends of the sheet are securely connected to each other. This tree guard is meant to prevent the young trees from being gnawed on by rodents and deer.

Potente, U.S. Pat. No. 6,379,459, provides a method for deterring arboreal animals from climbing and reaching a bird feeder, nesting box or elevated plant holder supported atop a post set within the ground and includes the steps of providing a freestanding, non-rotatable hollow, longitudinally extending body and inserting the post supporting the bird feeder, nesting box or elevated plant holder conjunctionally therein. Alternatively, the bird feeder, nesting box or elevated plant holder may be directly supported atop the freestanding, non-rotatable, longitudinally extending body.

Hancock-Bogese, et al, U.S. Pat. No. 6,113,076, provides a sheet of plastic used with a perimeter structure (e.g., fence) to prevent certain animals from climbing up the fence. The sheet of plastic is characterized by a smooth, slippery surface so that animals are unable to obtain a foothold on the sheet.

Faltinowski, U.S. Pat. No. 4,815,235, provides a device and method of use for protecting hunters and the like from attack by dangerous animals such as bears. The device has a body that fits around the perimeter of a tree trunk and control means attached thereto for discouraging a bear from climbing the tree. In one embodiment the body is divided into hinged body portions that can be fitted around a tree and closed by a clasp. In another embodiment the body consists of a plurality of bases that are strung together and retained to a tree by a belt. The device is fitted to the trunk of a tree which is climbed by the hunter.

Stone, U.S. Pat. No. 4,555,866, discloses a climbing animal barrier for tree trunks, poles, fences and walls. A barrier wall consisting of accordion-pleated metal cloth is bounded on its exterior by a solid metal skirt element which the climbing animal cannot grip or penetrate with its claws and thus is effectively prevented from circumventing the barrier. When applied to a tree trunk, the barrier can expand automatically with tree growth.

Carder, U.S. Pat. No. 2,999,479, discloses an animal restraining tree guard for protecting nests within a tree consisting of a disc-like body portion for placement around a tree, such disc-like body portion being secured in place by a plurality of finger-like projection extending towards the tree from such disc-like body portion.

Semmes, U.S. Pat. No. 1,017,920 discloses sheet metal piping, particularly useful for stove pipes, consisting of a pipe section having a hook on one edge and a double fold on the other with a longitudinal slot open at one end with which such hook cooperates and means for preventing the escape of the hook from the slot.

### SUMMARY OF THE INVENTION

The present invention provides an apparatus to prevent climbing a vertically disposed member. Such apparatus includes a covering member manufactured from a predetermined material and having a predetermined shape, a predetermined thickness, and a predetermined size. A securing means is operably connected to the covering member at a predetermined location thereon for securing the covering member at least one of to and around a predetermined object such that such object is rendered substantially incapable of being climbed upon at the location covered by the covering member.

### OBJECTS OF THE INVENTION

It is, therefore, one of the primary objects of the present invention to provide an apparatus which will protect objects and living beings positioned in a tree, as well as objects housed in or hung from a tree.

Another object of the present invention is to provide a means to deter animals such as bears, raccoon, and the like from climbing trees, posts, and poles and accessing and damaging feeders attached to such trees, posts, and poles.

Still another object of the present invention is to provide an apparatus which can be positioned around the trunk of a tree, a pole, and a post to prevent such tree, pole, and post from being climbed upon.

Yet another object of the present invention is to provide a simple device to protect food meant for deer, turkey, and other predetermined animals from pests, scavengers, varmints, and the like.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention in which the invention is secured around a portion of a tree to prevent the tree from being climbed and thereby protecting the feeding device attached to the tree.

FIG. 2 is a partial perspective view of the invention according to one embodiment of the invention in which a plurality of apertures are disposed along a first side end and a second side end of such covering member.

FIG. 3 is a partial perspective view of the invention according to one embodiment of the invention in which the apparatus is securable to at least one additional apparatus.

FIG. 4 is a partial perspective view of the invention according to one embodiment of the invention in which such apparatus is secured to one additional apparatus and in which both encircle a tree thereby increasing the surface area of such tree which is covered.

FIG. 5 is a partial perspective view of the invention according to another embodiment of the invention in which such covering member includes two semi-circular portions capable of being secured to each other.

FIG. 6 is a partial perspective view of the invention according to one embodiment of the invention in which such covering member includes two-semicircular portions releasably secured to each other by a screw-type fastening system.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

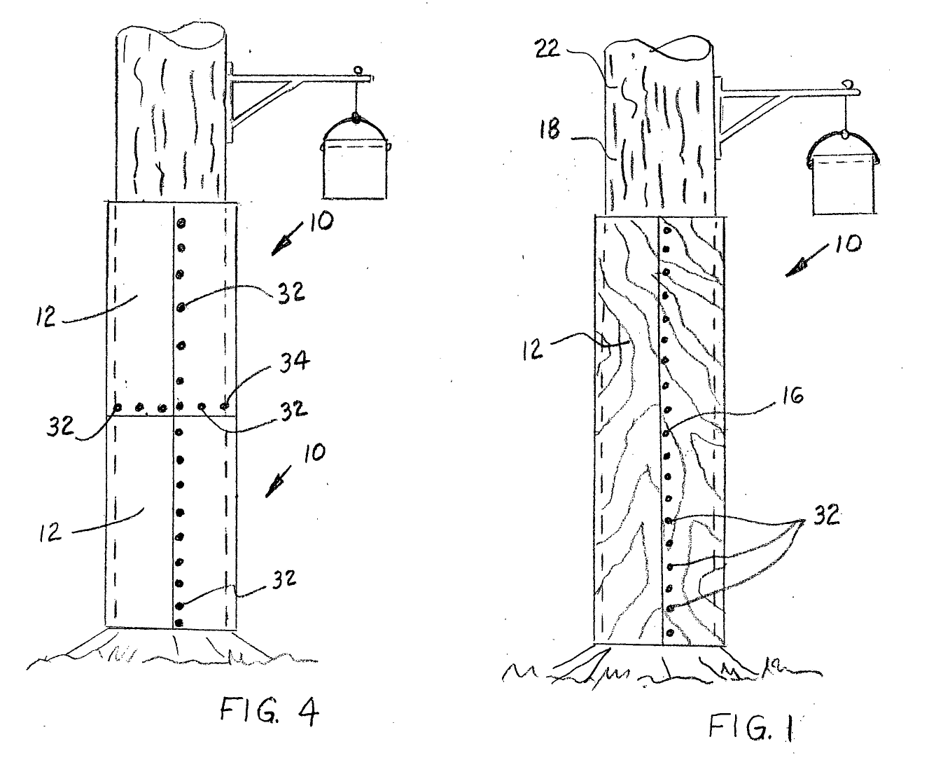

Reference is now made, more particularly, to FIGS. 1-6.

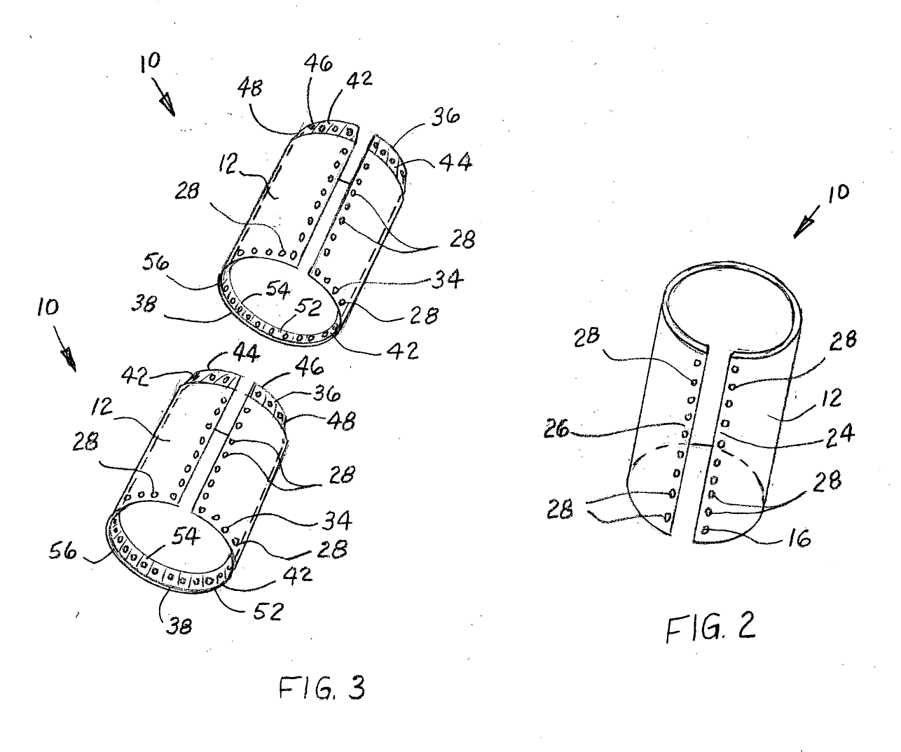

An apparatus, generally designated 10, to prevent climbing a vertically disposed member is provided. As illustrated in FIGS. 1-2, such apparatus 10 includes a covering member 12 manufactured from a predetermined material and having a predetermined shape, a predetermined thickness, and a predetermined size.

It is presently preferred that such predetermined material is at least one of a metal, a plastic, and a combination thereof. It is presently most preferred that such predetermined material is a metal. It is further presently preferred that such metal is a metal having a memory. It is also presently preferred that such metal is flexible.

It is presently preferred that such predetermined shape is substantially a cylinder. It is presently preferred that the diameter of such cylinder is between about 12.0 inches and 20.0 inches.

It is presently preferred that such covering member 12 is between about 40.0 inches and 50.0 inches high. It is presently preferred that the predetermined length of such covering member 12 is between about 45.0 inches and 55.0 inches.

It is presently preferred that such covering member 12 is at least one of smooth and slippery on an outside facing side 14. It is further presently preferred that such covering member 12 includes at least a portion decorated to resemble foliage, forestry, greenery, camouflage cloth, rock, tree bark, a predetermined animal's natural habitat, and a combination thereof.

A first securing means 16 is operably connected to the covering member 12 at a predetermined location thereon for securing the covering member 12 at least one of to and around a predetermined object 18 such that the object is rendered substantially incapable of being climbed upon at the location covered by the covering member. It is presently preferred that such predetermined object is at least one of a tree 22, a post, a pole, and the like.

It is presently preferred that the first securing means 16 is at least one of a snap type fastening system, at least one clamp, a screw type fastening system, a hook and eye type fastening system, a threaded member type fastening system and a combination thereof.

It is presently preferred that such covering member 12 includes a first side end 24 and a second side end 26 each having a plurality of apertures 28 disposed therethrough at predetermined locations thereon such that when such covering member 12 is placed around such predetermined object 18 the apertures 28 on the first side end 24 are capable of being aligned with the apertures 28 on the second side end 26.

It is presently preferred that such first securing means 16 includes a plurality of screws 32 for screwing into the plurality of aligned apertures 28.

Referring to FIGS. 3-4, it is further presently preferred that such covering member 12 further includes a second securing means 34 for securing such apparatus 10 to at least one additional apparatus 10.

It is further presently preferred that such second securing means 34 includes a plurality of apertures 28 being disposed along at least one of an upper end 36 and a lower end 38 of such covering member 12 at predetermined locations therethrough for being aligned with a predetermined plurality of apertures 28 disposed at predetermined locations through such at least one additional apparatus 10 and wherein the second securing means 34 further includes a plurality of screws 32 for screwing into the plurality of aligned apertures 28.

It is presently preferred that such covering member 12 further includes at least one beveled edge 42 at a predetermined location thereon for facilitating such apparatus 10 fitting together with such at least one additional apparatus 10.

It is further presently preferred that such covering member 12 includes a first beveled edge 44 adjacent an outside edge 46 of an upper end 48 of such covering member 12 and a second beveled edge 52 adjacent an inside edge 54 of a lower end 56 of such covering member 12.

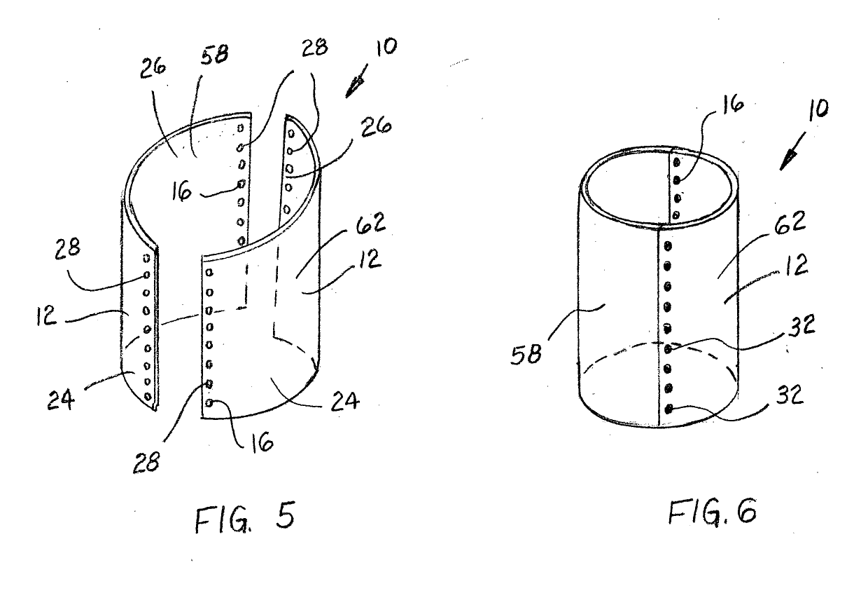

Referring to FIGS. 5-6, according to another embodiment of the invention, such covering member 12 includes a first elongated hollow semi-circular member 58 and a second elongated hollow semi-circular member 62, each semi-circular member being of a substantially identical predetermined size and such first member 58 being securable to such second member 62 by such first securing means 16.

According to this embodiment is it presently preferred that such first member 58 and such second member 62 each include a first side end 24 and a second side end 26 each having a plurality of apertures 28 disposed therethrough at predetermined locations such that when such first member 58 and such second member 62 are placed around such predetermined object 18 such apertures 28 on the first side end 24 of the first member 58 are capable of being aligned with the apertures 28 on the first side end 24 of the second member 62 and the apertures 28 on the second side end 26 of the first member 58 are capable of being aligned with the apertures 28 on the second side end 26 of the second member 62.

According to this embodiment, it is presently preferred that such first securing means 16 is at least one of a snap type fastening system, at least one clamp, a screw type fastening system, a hook and eye type fastening system, a threaded member type fastening system and a combination thereof. According to this embodiment, it is presently most preferred that such first securing means 16 includes a plurality of screws 32 for screwing into the plurality of aligned apertures 28.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An apparatus to prevent climbing a vertically disposed member, said apparatus comprising;
a. a covering member manufactured from a predetermined material and having a predetermined shape, a predetermined thickness, and a predetermined size; and
b. a first securing means for securing said covering member at least one of to and around a predetermined object such that such object is rendered substantially incapable of being climbed upon at the location covered by said covering member, said securing means being operably connected to said covering member at a predetermined location thereon.

2. An apparatus according to claim 1 wherein said covering member is at least one of smooth and slippery on an outside facing side.

3. An apparatus according to claim 1 where said predetermined material is at least one of a metal, a plastic, and a combination thereof.

4. An apparatus according to claim 1 wherein said predetermined material is a metal.

5. An apparatus according to claim 4 wherein said metal is flexible.

6. An apparatus according to claim 4 wherein said metal is a metal having a memory.

7. An apparatus according to claim 1 wherein said first securing means is at least one of a snap type fastening system, at least one clamp, a screw type fastening system, a hook and eye type fastening system, a threaded member type fastening system and a combination thereof.

8. An apparatus according to claim 1 wherein said covering member includes a first side end and a second side end each having a plurality of apertures disposed therethrough at predetermined locations thereon such that when said covering member is placed around said predetermined object said apertures on said first side end are capable of being aligned with said apertures on said second side end.

9. An apparatus according to claim 8 wherein said first securing means includes a plurality of screws for screwing into said plurality of aligned apertures.

10. An apparatus according to claim 1 wherein said predetermined shape is substantially a cylinder.

11. An apparatus according to claim 10 where said diameter of said cylinder is between about 12.0 inches and 20.0 inches.

12. An apparatus according to claim 1 wherein said covering member is between about 40.0 inches and 50.0 inches high.

13. An apparatus according to claim 1 wherein said predetermined length of said covering member is between about 45.0 inches and 55.0 inches.

14. An apparatus according to claim 1 wherein said covering member further includes a second securing means for securing said apparatus to at least one additional apparatus.

15. An apparatus according to claim 14 wherein said second securing means includes a plurality of apertures being disposed along at least one of an upper end and a lower end of said covering member through predetermined locations thereon for being aligned with a predetermined plurality of apertures disposed through predetermined locations on said at least one additional apparatus and wherein said second securing means further includes a plurality of screws for screwing into said plurality of aligned apertures.

16. An apparatus according to claim 14 wherein said covering member further includes at least one beveled edge at a predetermined location thereon for facilitating said apparatus fitting together with said at least one additional apparatus.

17. An apparatus according to claim 16 wherein said covering member includes a first beveled edge adjacent an outside edge of an upper end of said covering member and a second beveled edge adjacent an inside edge of a lower end of said covering member.

18. An apparatus according to claim 1 wherein said covering member includes a first elongated hollow semi-circular member and a second elongated hollow semi-circular member, each semi-circular member being of a substantially identical predetermined size and said first member being securable to said second member by said first securing means.

19. An apparatus according to claim 18 wherein each of said first and second members include a first side end and a second side end each having a plurality of apertures disposed therethrough at predetermined locations thereon such that when said covering member is placed around said predetermined object said apertures on said first side end of said first member are capable of being aligned with said apertures on said first side end of said second member and said apertures on said second side end of said first member are capable of being aligned with said apertures on said second side end of said second member.

20. An apparatus according to claim 1 wherein said covering member includes at least a portion decorated to resemble foliage, forestry, greenery, camouflage cloth, rock, tree bark, a predetermined animal's natural habitat, and a combination thereof.
